(19) United States
(12) Patent Application Publication
(10) Pub. No.: US 2024/0244277 A1
(43) Pub. Date: Jul. 18, 2024

(54) SERVER METHOD AND COMPUTER PROGRAM

(71) Applicant: 17LIVE Japan Inc., Tokyo (JP)

(72) Inventor: Mu-Yun PA, Taipei City (TW)

(21) Appl. No.: 18/357,791

(22) Filed: Jul. 24, 2023

(30) Foreign Application Priority Data
Jan. 18, 2023 (JP) 2023-006189

(51) Int. Cl. H04N 21/2187; H04N 21/431

(52) U.S. Cl. CPC H04N 21/2187; H04N 21/431

(57) ABSTRACT

A server for setting configurations in live streaming platform, comprising: obtaining configuration setting data from a database; wherein the configuration setting data includes configuration file and definition file; generating an UI object according to the configuration setting data; receiving an operation from an user via the UI object; and updating the configuration setting data in the database. The present disclosure may reduce the learning curve for the engineers and administrators to set the configuration, reduce human error by the engineers or administrators, and more functionalities may be added to the platform. Therefore, the quality of the server may be improved.

This application is based on and claims the benefit of priority from Japanese Patent Application Serial No. 2023-006189 (filed on Jan. 18, 2023), the contents of which are hereby incorporated by reference in its entirety.

### TECHNICAL FIELD

This disclosure relates to information and communication technology, and in particular, to a server, method and computer program for setting configuration in a live streaming platform.

### BACKGROUND

Some APPs or platforms provide live streaming service for streamers and viewers to interact with each other. The streamers may have a performance to cheer up the viewer and the viewer may send gifts to support the streamers.

In order to realize the interaction, a lot of configurations need to be set in the platform. Patent Document 1 discloses a method to set the configurations of a business process by dragging blocks in a communication interface. In patent document 1, it also discloses that the service types may include payment service, order service, live video service and the like.
[Patent Document 1]: CN113885842A

However, some configurations need to be set in a more complicated manner. It takes time and effort for the engineers and administrators to finish setting configurations. Therefore, it is important to provide a more accurate and convenient way to improve the configuration setting procedure.

### SUMMARY

An embodiment of subject application relates to a server for setting configurations in live streaming platform, comprising: obtaining configuration setting data from a database; wherein the configuration setting data includes configuration file and definition file; generating an UI object according to the configuration setting data; receiving an operation from an user via the UI object; and updating the configuration setting data in the database.

Another embodiment of subject application relates to a method for setting configurations in live streaming platform, comprising: obtaining configuration setting data from a database; wherein the configuration setting data includes configuration file and definition file; generating an UI object according to the configuration setting data; receiving an operation from an user via the UI object; and updating the configuration setting data in the database.

Another embodiment of subject application relates to a computer program for causing a server to realize the functions of: obtaining configuration setting data from a database; wherein the configuration setting data includes configuration file and definition file; generating an UI object according to the configuration setting data; receiving an operation from an user via the UI object; and updating the configuration setting data in the database.

The present disclosure may reduce the learning curve for the engineers and administrators to set the configuration, reduce human error by the engineers or administrators, and more functionalities may be added to the platform. Therefore, the quality of the server may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 is a schematic configuration of a configuration setting system 2 according to some embodiments of subject application;

FIG. 5 is a schematic block diagram of the reading procedure of the configuration setting system 2 according to some embodiments of subject application;

FIG. 6 is a schematic block diagram of the writing procedure of the configuration setting system 2 according to some embodiments of subject application;

FIG. 7 is a schematic block diagram of the visualization procedure of the configuration setting system 2 according to some embodiments of subject application;

FIG. 8 shows an exemplary data structure of the configuration storage 320 of FIG. 3;

FIG. 9 shows an exemplary data structure of the definition storage 322 of FIG. 3;

FIG. 10 is exemplary screen image of the visual editor in the configuration setting system 2 according to some embodiments of subject application;

FIG. 11 is an exemplary flow chart illustrating an operation of the configuration of the configuration setting system 2 according to some embodiments of subject application:

FIG. 12 is an exemplary flow chart illustrating an operation of the configuration of the configuration setting system 2 according to some embodiments of subject application;

FIG. 13 is an exemplary sequence chart illustrating an operation of the configuration of the configuration setting system 2 according to some embodiments of subject application;

FIG. 14 is an exemplary hardware configuration of the information processing device according to some embodiments of subject application.

### DETAILED DESCRIPTION

Hereinafter, the identical or similar components, members, procedures, or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

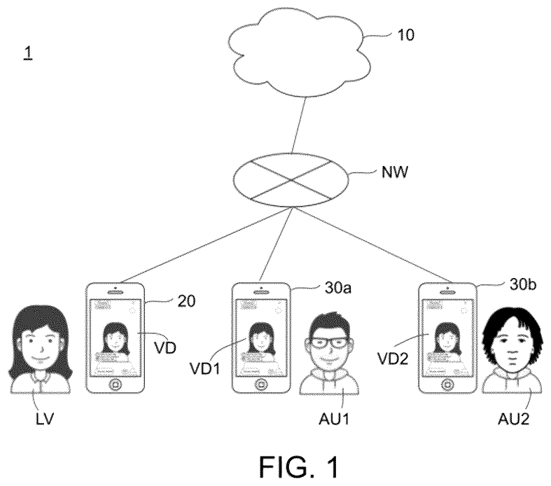

FIG. 1 shows a schematic configuration of a live streaming system 1 according to some embodiments of subject application. The live streaming system 1 provides a live streaming service for the streaming streamer (may also be referred as live or streamer) LV and viewer (may also be referred as audience) AU (AU1, AU2 . . . ) to interact mutually in real-time. As shown in FIG. 1, the live streaming system 1 may include a server 10, a user terminal 20 and a user terminal 30(30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10 and be the one who distributes contents in real-time. In some embodiments, the streamer LV may interact with the viewer AU via the live streaming.

The APP provider may provide a platform for the contents to go on live streaming in the server 10. In some embodiments, the APP provider may be the media or manager to manage the real-time communication between the streamer LV and viewer AU. The viewer AU may access the platform by the user terminal 30 to select and watch the contents he/she would like to watch. The viewer AU may perform operations to interact with the streamer, such as commenting or cheering the streamer, by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a comment on the contents of the streamer LV into the user terminal 30a, the server 10 will display the comment on the user terminal 20 of the streamer in real-time, and also display on the user terminal 30a, 30b of the viewer AU1, AU2 respectively. If the streamer LV responds to the comment, the response may be outputted as the text, image, video or audio from the terminal 30a, 30b of the viewer AU1, AU2, so that the communication of the streamer LV and viewer LV may be realized. Therefore, the live streaming system may realize the live streaming of two-way communication.

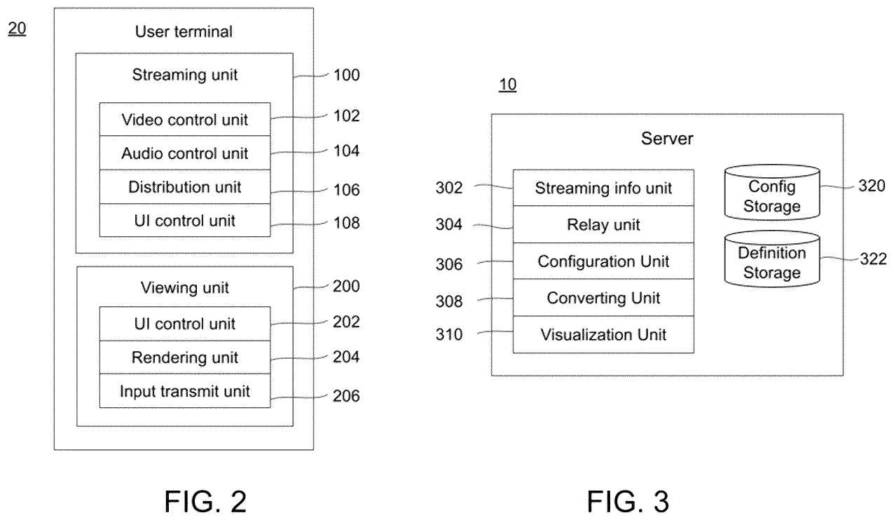

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the streamer.

FIG. 3 is a schematic block diagram of the server 10 according to some embodiments of the subject application. The server 10 may include streaming info unit 302, relay unit 304, configuration unit 306, converting unit 308, visualization unit 310, configuration storage 320 and definition storage 322.

The streaming info unit 302 receives the request of live streaming from the user terminal 20 of the streamer via the network NW. Once receiving the request, the streaming info unit 302 registers the information of the live streaming on a stream DB (not shown). In some embodiments, the information of the live streaming may be the stream ID of the live streaming, the streamer ID of the streamer or the viewer ID of the viewer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming. The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30.

The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The configuration unit 306 is configured to handle configurations in Server 10. More specifically, the configuration unit 306 may pull configuration setting data from an external database. The configuration setting data may be programmed and uploaded to the external database by the engineers. In some embodiments, the external database may also be an internal database in server 10. In some embodiments, the external database may be a third-party service such as GitHub, google drive or the like. In some embodiments, the server 10 may include a local repository to store the configuration setting data temporarily or permanently. The configuration unit 306 may pull configuration setting data from external databases and store them in local databases for further use.

The configuration setting data may include configuration file and definition file or the like. The configuration file may be the source code or programming code of the configurations such as features, events, settings or the like. The configuration file may include parameters for setting configuration such as event duration, frame color or the like. The definition file may include information related to the configuration file. In some embodiments, the definition file may include the definitions of the parameters or settings in the configuration file. The definition may include, for example, the value, range, type or format of the parameters or the like. In some embodiments, the configuration setting data may include parameters related to interactions among streamers and viewers in the live streaming platform.

The configuration unit 306 may pull the latest configuration setting data from the database. For example, there may be different configuration files in different branches in GitHub such as the main branch or sub-branches. If there is an update of the configuration file in one branch, the configuration unit 306 may pull the latest configuration setting data from GitHub. In some embodiments, the configuration unit 306 may also store the configuration setting data in the local repository. In some embodiments, the configuration files and definition files may be pulled from the same or different repositories from external databases and may be stored in the same or different local repositories in server 10. In some embodiments, the remote and local repository may be adjusted according to the practical need.

The configuration unit 306 may further transmit the configuration data to the frontend for administrators to set configurations. In some embodiments, the administrators may perform operations such as editing, amending or updating parameters on the configuration setting data. The configuration unit 306 may push the updated configuration setting data to the corresponding database in order to complete the configuration setting. In some embodiments, the configuration setting data may be converted to suitable format by converting unit 308. In some embodiments, the configuration setting data may further be visualized by visualization unit 310 and provided to the administrators.

The converting unit 308 is configured to convert the configuration setting data. The converting unit 308 may receive configuration setting data from the configuration unit 306 and convert the configuration setting data to suitable format for further use. For example, the configuration file may be programmed in a YAML file and the definition file may be programmed in JSON schema or the like. The converting unit 308 may convert the configuration setting data into the same or compatible format. In some embodiments, the configuration setting data may be programmed as or converted into any possible languages such as YAML, JSON, XML, HTML, C++, JavaScript, Python or the like.

In some embodiments, the configuration file may be programmed in YAML, and the converting unit 308 may convert the configuration file from YAML file to JSON object or the like. In some embodiments, the YAML file may be transformed into Document Nodes first and then converted into the JSON object. One advantage to using Document Nodes is that the metadata in the configuration file such as comment, annotation, attribute, order or the like may be fully saved. The data structure of Document Nodes may prevent the metadata from being lost during the transformation and conversion.

In some embodiments, the YAML file may be transformed into Document Nodes by any possible methods such as the third-party library “js-yaml” or the like. In some embodiments, the Document Nodes may further be converted into JSON objects by any possible methods such as the built-in method of “toJSON( )” function or the like.

In some embodiments, the converting unit 308 may check whether the configuration setting data includes the corresponding definition file to the configuration file. If there is no corresponding definition file to the configuration file, the server 10 may generate a code editor for the administrator to set configuration in the code editor. The administrator may also perform operations such as modifying the parameters in the code of the configuration file.

The visualization unit 310 is configured to visualize the configuration setting data. As stated above, the configuration setting data may include configuration file and definition file. The definition file may be programmed in JSON Schema. The JSON Schema is a declarative language that allows programmers to annotate and validate JSON documents. The JSON Schema may mainly be used to describe the data structure of the JSON object and the format of parameters such as the attribute or the like. The contents in the JSON Schema may also be used to verify the correctness of the data format or the like.

During the visualization procedure, the visualization unit 310 may generate a visual editor according to the JSON object and JSON Schema. More specifically, the visualization unit 310 may transform the JSON object into a visualization interface according to the definition in the definition file. In some embodiments, the JSON object may be transformed into the visualization interface by the third-party library such as “react-jsonschema-form” or the like. The library of “react-jsonschema-form” may transform the JSON object into corresponding components according to the contents of JSON Schema in the definition file. In some embodiments, the component may be an input field, color picker, date picker, pull-down menu or the like. In some embodiments, the component may be designed according to the practical need.

In some embodiments, the configuration file may include a plurality of parameters and the visualization unit 310 may transform the parameters into corresponding components according to the format of the parameters. For example, if the parameter is a color for a frame, the visualization unit 310 may transform the parameter into the color component. The color component may include a field for the administrator to fill in color code, or include a color picker for the administrator to select the color or the like. If the parameter is related to an enumerated data type, the parameter may be transformed into the component of the pull-down menu or the like. According to the embodiments, parameters with the same format may be transformed into the same component. The engineers only need to create one component for the parameters with the same format. Therefore, the efficiency of the system may be improved.

In some embodiments, the visualization unit 310 may verify the correctness of the configuration. For example, the administrator may upload an image of an avatar and fill in the URL of the image to set the configuration of the avatar. In the definition file, the parameter of the URL may be defined as a string format with at least one character, and the format of the string should conform to the URL format. Once the user fills in an input, the visualization unit 310 may verify the format of the input. In some embodiments, the visualization unit 310 may disable the save button until all the parameters are verified.

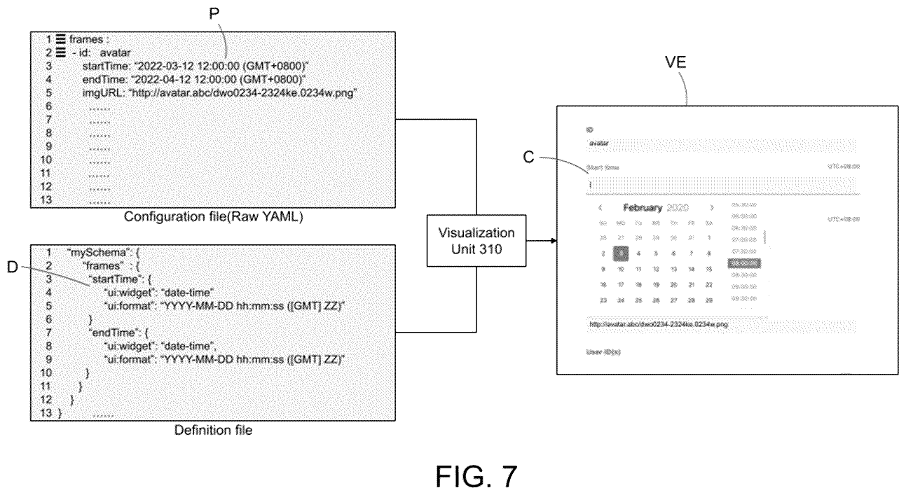

FIG. 7 is a schematic block diagram of the visualization procedure of the configuration setting system 2 according to some embodiments of subject application. As shown in FIG. 7, the visualization unit 310 may visualize the configuration setting data into a visualization object. The visualization unit 310 may transform parameters P into corresponding components C and generate a visual editor VE according to the configuration file and the definition file.

For example, the parameter P of “startTime” may have the definition D in the corresponding definition file. The visualization unit 310 may transform the parameters P into the corresponding component C according to the definition D. The component C may include the input field or date picker or the like. According to the embodiments, the component for each format of parameter may be designed flexibly by the engineers and the same format of parameters may be transformed into the same component. Therefore, the flexibility and convenience of the system may be improved.

In some embodiments, the APP or platform provider may provide events for the streamers to participants, and also provide gifts for the viewer to send to the streamers via the server 10. The administrators may set the parameters for the events. The parameters may include the duration of the event such as the starting time and ending time or the like. The parameters may also include the icon, points, gift ID of the event gift. In some embodiments, the engineers may program the configuration file as a YAML file and the administrators may set the parameters in the YAML files to customize the configurations for each event.

In some embodiments, the engineers may further create the definition file and the converting unit 308 and visualization unit 310 may convert and visualize the configuration setting data into a visualization object for the administrator to set configuration. For example, the administrator may set the starting time and ending time of each event to customize different events. The YAML file of the configuration file may include the parameters of the starting time, ending time or the like. In some embodiments, the definition file may include the definition of the parameters such as the format of the starting time and ending time, the corresponding component of the parameters or the like. In some embodiments, the definition file may also be generated automatically by AI technology, machine learning technology or the like.

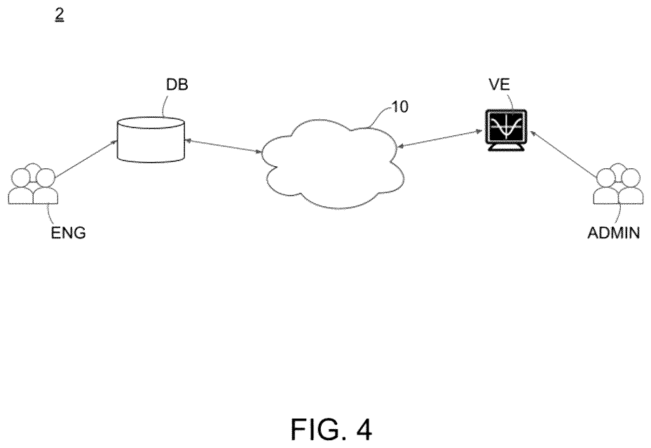

FIG. 4 is a schematic configuration of a configuration setting system 2 according to some embodiments of subject application. The configuration setting system 2 provides a configuration setting service for the engineer ENG and administrator ADMIN to set configuration. As shown in FIG. 4, the configuration setting system 2 may include the server 10, engineer ENG, administrator ADMIN, an external database DB and visual editor VE. The engineer ENG may be engineers who program the configuration setting data and the administrator ADMIN may be administrators who set the configurations. The external database DB may be the database to store the configuration setting data such as programming code or source code. In some embodiments, the database DB may also be an internal database in server 10. The visual editor VE may be an interface for the administrator ADMIN to set configuration. The engineer ENG and administrator ADMIN may communicate by any possible terminal, computer or the like. The communication in the configuration setting system 2 may be realized by any type of wire or wireless network NW.

In the configuration setting system 2, reading procedure and writing procedure may be realized. The reading procedure is to obtain the configuration setting data from the database and generate visual editor VE for the administrator ADMIN. The writing procedure is to obtain the operations on the configuration setting data from the visual editor VE and update the configuration setting data in the database. In some embodiments, server 10 may be one server to realize the configuration setting, release and deployment or the like. In some embodiments, server 10 may include several servers to realize the configuration setting, release and deployment respectively. For example, the configuration setting may be realized by an administrator server and the configuration release and deployment may be realized by another server respectively.

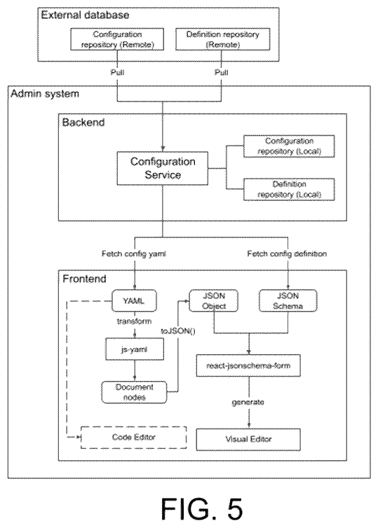

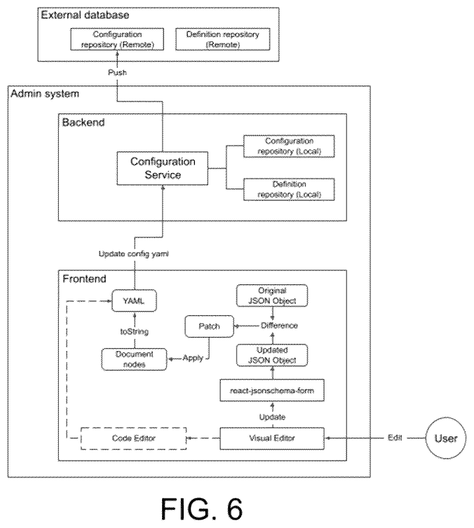

FIG. 5 and FIG. 6 are schematic block diagrams of the reading procedure and writing procedure of the configuration setting system 2 according to some embodiments of subject application. Here, the external database DB may be the GitHub system, the backend may be referred to as the configuration unit 306, and the frontend may be referred to as the converting unit 308 and visualization unit 310.

As shown in FIG. 5, the configuration service may pull the latest configuration setting data from an external database. More specifically, the external database may include the configuration repository and definition repository to store the configuration file and definition file respectively. Engineers may program and upload the configuration setting data to the external database. Once the configuration setting data is updated, the configuration service may pull the latest configuration setting data to the server 10.

The configuration service may store the configuration setting data in local storage in server 10. More specifically, server 10 may include local configuration repository and local definition repository. In some embodiments, the local repository may be an internal storage or a third-party service such as the ETCD or the like. In some embodiments, the pull and push of configuration setting data may be realized by, for example, the Git system, the ETCD or the like.

Once the request of setting configuration is made, the frontend may fetch the configuration setting data from the configuration service. Here, the configuration file may be the file in YAML and the definition file may be the file in JSON Schema. The YAML file may be transformed into JSON Object for the preparation of visualization. As shown in FIG. 5 as an embodiment, the YAML file may be transformed into the Document Nodes by the library of “js-yaml” and then converted into a JSON object by the method of function “toJSON( )” in JavaScript or the like. The method for transforming files into suitable format may be flexibly realized by built-in functions, third-party libraries or the like.

Moreover, the frontend may visualize the configuration setting data for the administrator to set configuration. As shown in FIG. 5, the JSON object and JSON schema may be transformed by a built-in or third-party library and generate a visual editor such as UI interface. More specifically, the JSON Object may be transformed into a UI interface by a third-party library according to the contents in JSON Schema. The third-party library may be a library of “react-jsonschema-form” or the like. The administrator may set configurations by the visual editor to realize the configuration setting.

In some embodiments, if there is no corresponding definition file to the configuration file, the frontend may generate a code editor from the configuration file for the administrator to set configuration. For example, the frontend may display the code of raw YAML file for the administrator to fill in or change the parameters in order to set the configuration.

As shown in FIG. 6, the user, which may be the administrator, may edit the visual editor. For example, the administrator may set the parameter of the duration, event gift, banner or the like. Once the parameters are set, the visual editor may update the JSON object. The JSON object may also be updated by a library such as “react-jsonschema-form” or the like. According to the attribute of the library, the JSON Object may be updated automatically and dynamically while the user is editing the visual editor.

Once the JSON Object is updated, the frontend may compare the difference between the updated JSON Object and the original JSON Object. A patch file may be generated according to the difference. The patch file may be the file containing changes to be applied to another file or files. In some embodiments, the patch file may record the difference between the updated JSON Object and the original JSON Object. For example, if the user changes the value of parameter “a.b.c.d” with “2”, the patch file may record the information.

Furthermore, the record of the differences in the patch file may be applied to the Document Nodes dynamically in real-time. In some embodiments, the patch file may be used for updating the operations from the user on the visual editor. The visualization unit may update the operations in real-time on the visual editor according to the difference recorded in the patch file or the like. After all the changes are verified and reflected on the visual editor, the administrator may confirm the configuration. For example, the visual editor may include a “save” button or the like for the administrator to confirm the configuration setting. Once the “save” button is clicked by the administrator, the Document Nodes may be transformed into YAML strings and transmitted to the backend in the API body via an API. The Document Nodes may be transformed back to a YAML file by built-in methods in programming language such as “tostring( )” or the like.

In some embodiments, the configuration setting system may include the visual editor and code editor for the administrators to set configuration in a more flexible manner. The administrators may switch to the suitable interface to perform operations on the configuration setting system 2.

Once the configuration service receives the request of updating configuration, the configuration service may store the updated configuration setting data in the local repository. Further, the configuration service may push the updated configuration setting data to the remote repository in an external database. Therefore, the configuration setting procedure may be realized in a more accurate and smooth manner.

According to the embodiments, the configuration setting procedure may be improved. In general, the configuration setting data is programmed and managed by professional engineers. For example, YAML is a human-readable data-serialization language and is commonly used for configuration files. However, it takes time and effort for the administrator to understand the programming language and learn how to set the configurations. If a wrong format of configuration is set and is not noticed by the user, it may cause an error or crash of the system.

The visualization of the configuration setting data makes the configuration setting procedure more intuitive and easier to perform. More features such as previewing, supplemental message and hint may be provided additionally. Therefore, human error due to unfamiliarity with the programming language may be reduced and the configuration setting procedure may be improved.

According to the embodiments, the configuration setting data may be verified while being edited, and the instability of the system due to human error may also be reduced. More specifically, the definition file may include the rule and format of each parameter and field, so the format of the parameters in the configuration setting data may be verified dynamically in real-time while the configurations are being set by the administrators. Therefore, the quality of the system may be improved.

Moreover, the visualization interface may allow the user to set the configuration in a more flexible manner and the operability may also be improved. For example, the object in the URL may be shown in the visual editor. The user may preview the object without extra procedure such as copying and pasting the URL on a browser. The feature of previewing or the like may all be set and designed in the definition file. Therefore, the flexibility of the configuration setting system 2 may be improved.

Furthermore, the definition file may be amended or modified without extra deployment and the configuration setting procedure may be improved. For example, the configuration file and definition file may be stored in an external database such as GitHub repository. When a new version of configuration setting data is uploaded to the external database, the latest version of configuration file and definition file may be pulled to the server 10. Therefore, if a new definition file needs to be created or a current definition file needs to be amended, it may simply be adjusted by the external database such as the GiHub or Git system without further release or deployment.

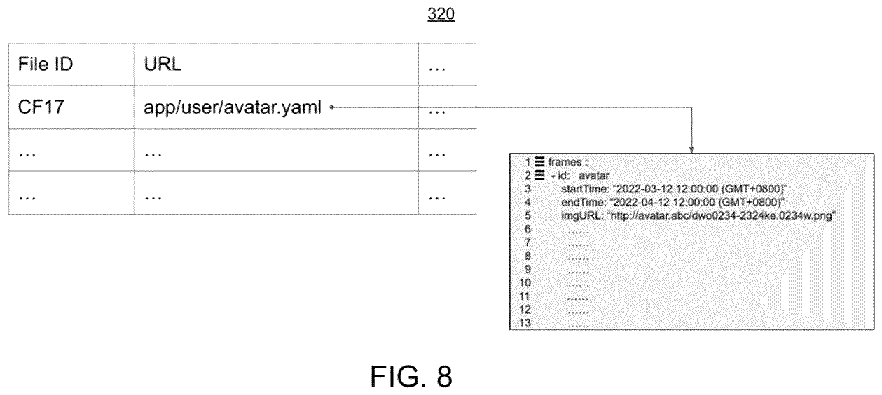

FIG. 8 shows an exemplary data structure of the configuration storage 320 of FIG. 3. The configuration storage 320 associatively stores the file ID identifying the configuration files, and the URL identifying the location of the configuration file, in association with each other. The appearance of the configuration file is also shown in FIG. 8 for reference. In some embodiments, the configuration file may be programmed in a YAML file and include parameters for setting configuration.

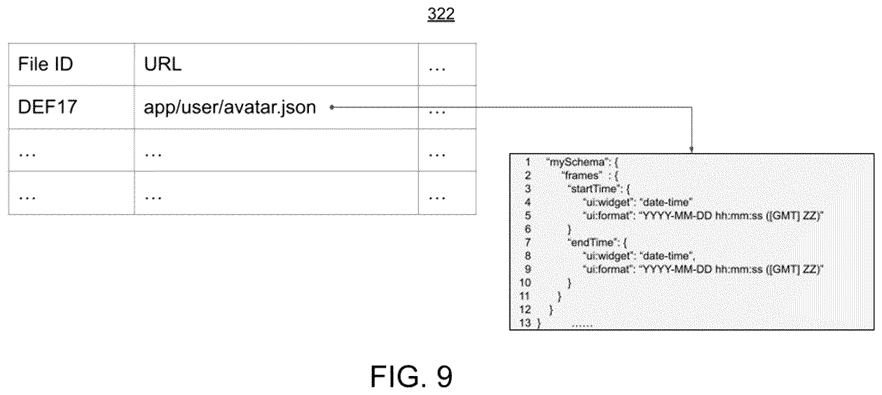

FIG. 9 shows an exemplary data structure of the definition storage 322 of FIG. 3. The definition storage 322 associatively stores the file ID identifying the definition files, and the URL identifying the location of the definition file, in association with each other. The appearance of the definition file is also shown in FIG. 9 for reference. In some embodiments, the definition file may be programmed in JSON Schema file and include information of the parameters such as definition, format or the like.

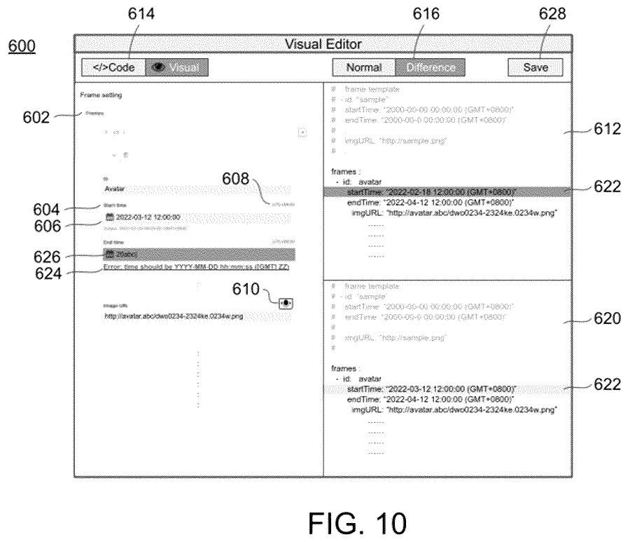

FIG. 10 is an exemplary visual editor 600 of the configuration setting system 2 according to some embodiments of subject application. As shown in FIG. 10, the visual editor 600 may include an UI object 602. In some embodiments, the UI object 602 may be a visualization form for the user to set configuration such as change parameters, upload objects or the like. The UI object 602 may include the information of the configuration such as the title 604 and input field 606 of the parameters. The administrator may set the parameters such as starting time and ending time of an event to customize an event.

In some embodiments, the visual editor 600 may guide the user while the user is setting the configuration. For example, an information object 608 may be shown to indicate the information of the parameters such as unit, standard, range, format or the like. In some embodiments, a helper such as date picker, color picker or the like may also be shown to help the user with setting the parameters. In some embodiments, a preview 610 of the image, icon, video or the like may also be displayed on the UI object 602 for the user's reference. For example, if an URL or file of an image is filled in by the user, the preview 610 of the image may be shown on the visual editor 600.

The visual editor 600 may include the code info 612 of the configuration file. For example, the programming code of the configuration file may be shown in the code info 612. The code info 612 may be the code editor for the user to amend the code, or the code viewer for the user to view the code or the like. In some embodiments, the changes in the configuration setting may be reflected to the code into 612 in real-time. For example, the portion the user changed may be highlighted for the user's reference. In some embodiments, the code info 612 of the configuration file may further include two portions to display the original and updated configuration file. According to the embodiments, the human error may be reduced and the accuracy of the configuration setting may be improved.

In some embodiments, the visual editor 600 may include a switch 614 for the administrator to switch between the visual editor and code editor. In some embodiments, the visual editor 600 may include a switch 616 for the administrator to switch between normal mode and difference mode. In normal mode, the code info 612 may be displayed next to the visual editor. The inputs and the changes from the visual editor may be reflected on the code info 612 in real-time. In difference mode, a code info 620 may further be displayed below the code info 612 to show the updated configuration file in comparison with the original configuration file in code info 612. In some embodiments, the layout of the visual editor 600 may be adjusted flexibly according to the practical need.

In some embodiments, updated portions may also be highlighted by an object 622 such as shadow or the like. In some embodiments, if the format of parameter is not correct, a supplemental message 624 such as “Error: time should be YYYY-MM-DD hh:mm:ss ([GMT] ZZ)” may also be shown as a hint for the reference. In some embodiments, a guide object 626 such as time picker, date picker, color picker may also be provided for the administrator to set parameters. In some embodiments, a save button 628 may also be provided for the administrator to confirm the completion of setting configuration.

In some embodiments, the visual editor may include a search bar for the user to search the parameters, configurations or the like. The visual editor may include a pin function for the user to pin the information of configuration setting on the top of the visual editor or the like. The visual editor may provide historical records for the users to check their previous operations or the like. In some embodiments, the visual editor may further provide the definition editor for the engineers to edit the definition file in real-time. In some embodiments, the visual editor may provide the version control function for the user to select the version of configuration setting data. In some embodiments, the visual editor may be designed and determined according to the practical need.

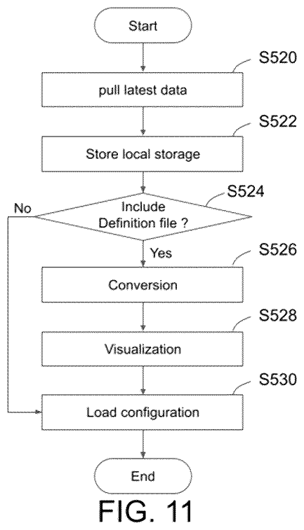

The operation of the configuration setting system 2 with the above configuration will be now described. FIG. 11 is a flowchart showing steps of the reading procedure in the configuration setting system 2. Once the engineers upload the configuration setting data in the database, the configuration unit 306 may pull the latest configuration setting data from the database (S520). In some embodiments, the configuration unit 306 may also store the configuration setting data in a local repository (S522). Once there is new configuration setting data, the frontend may fetch the configuration setting data from the configuration unit 306.

In some embodiments, the frontend may check whether the configuration setting data includes a corresponding definition file to the configuration file (S524). More specifically, the frontend may check whether there is a definition file for the YAML file. For example, the YAML file may include the record and location of the definition file. In some embodiments, the YAML and definition file may share the same filename with different file extensions, so the frontend may check the existence of the definition file according to the filename, filepath or the like. For example, for a configuration of avatar features, the YAML file may be “avatar.yaml” and the definition file may be “avatar.json” or the like. The converting unit 308 may check whether there is a file having the same filename with specific file extensions to determine whether the configuration setting data includes the definition file or not. For example, the file extension of the configuration file may be “ymal” and the file extension of the definition file may be “json” or the like. The configuration file may be kept in the same location as the definition file so they may share the same file path. The definition file may also be kept in a separated location from the configuration file. In this situation, the frontend may check whether there is a file having the same filename with specific file extensions in the corresponding location to confirm the existence of the definition file. According to the embodiments, the complexity of the system may be reduced and the quality of the system may also be improved.

If there is no corresponding definition file to the configuration file (NO in S524), the frontend may directly load the configuration setting data (S530). For example, the frontend may load the raw YAML file for the administrator to set configuration. If there is a corresponding definition file to the configuration file (YES in S524), the converting unit 308 may convert the configuration setting data into suitable format (S526). The visualization unit 310 may further visualize the configuration setting data into an visual editor such as UI interface or the like (S528). In some embodiments, the frontend may further load the configuration setting data (S530). Therefore, the configuration setting interface may be a visual editor, raw YAML file, combination of above or the like.

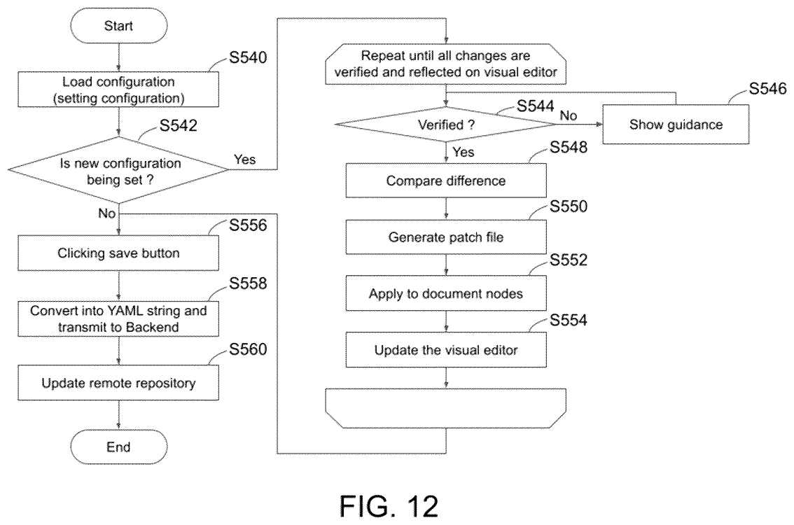

FIG. 12 is a flowchart showing steps of the writing procedure in the configuration setting system 2. When the administrators get access to the configuration setting system 2, the frontend may load the configuration (S540) for the administrator to set configuration. The administrators may set or change the configuration setting data in the visual editor VE. If there is a new configuration set by the administrators (YES in S542), the frontend may repeat the following steps S544, S546, S548, S550, S552 and S554 until all the changes are handled by the visualization unit 310.

The visualization unit 310 may verify the changes according to the definition file (S544). For example, if the changes are related to a date, the visualization unit 310 may verify whether the changes are consistent with the format of the date. If the changes do not conform to the format (NO in S544), the visualization unit 310 may show guidance such as supplemental messages or hints on the visual editor to help the user with configuration settings. For example, if the input should conform to the format of UUID, a message of “should match format UUID” may be shown below to indicate the error of the input. According to the embodiments, human error may be reduced during configuration setting and the quality of the system may be improved.

If the changes conform to the format (YES in S544), the frontend may compare the differences between the original and updated configuration setting data (S548). The converting unit 308 may generate a patch file recording the differences (S550). The converting unit 308 may apply the differences to the Document Nodes (S552). Furthermore, the visualization unit 310 may update the visual editor dynamically in real-time (S554).

For example, the visual editor may include UI interface and raw YAML file. Once the administrator updates a parameter, the corresponding changes may be reflected on the YAML file. In some embodiments, the raw YAML file may further include the original and updated YAML file for reference. In some embodiment, the changes may also be highlighted by color, hatching, shading or the like. According to the embodiments, the configuration setting procedure may be improved.

If there is no new configuration set by the administrators (NO in S542), or after all the changes are verified and reflected on the visual editor, the administrators may confirm the configuration setting by, for example, clicking the save button (S556). The converting unit 308 may further convert the updated configuration setting data into suitable format (S558). For example, the converting unit 308 may transform the Document Nodes into YAML string and transmit to the Backend in an API body via the API (S558). The configuration unit 306 may further update the configuration setting data to the remote database (S560). In some embodiments, the configuration unit 306 may update the configuration setting data in the local repository and push the updated configuration setting data to the remote repository. According to the embodiments, the configuration setting procedure may be improved.

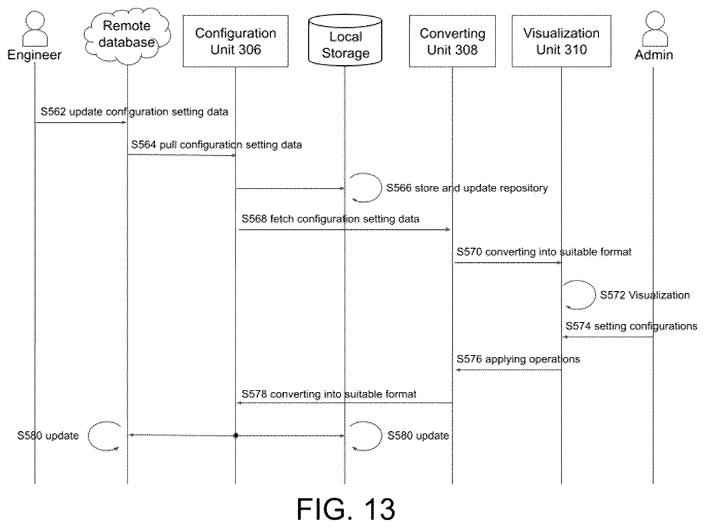

FIG. 13 is an exemplary sequence chart illustrating an operation of the configuration of the configuration setting system 2 according to some embodiments of subject application. In some embodiments, the engineers may program and upload the configuration setting data in a remote database (S562). The configuration unit 306 may pull the latest configuration setting data in response to the upload (S564). In some embodiments, the configuration unit 306 may store the configuration setting data in a local repository (S566)

The converting unit 308 may fetch the configuration setting data (S568) and convert the configuration setting data into suitable format (S570). In some embodiments, the conversion may be used for the preparation of visualization. The visualization unit 310 may further visualize the configuration setting data into the visual editor (S572). In some embodiments, the visual editors may be an UI interface, form or the like

The administrators may set configurations on the visual editor (S574). In some embodiments, the administrators may perform operations such as fill in, change, upload or modify the configuration setting data. The operation performed by the administrators may be applied to the configuration setting data (S576). The converting unit 308 may further convert the configuration setting data into suitable format (S578). In some embodiments, the updated configuration setting data may be converted back into the original format such as a YAML file or the like. The configuration unit 306 may further update the configuration setting data in the local repository and push to the remote database (S580). According to the embodiments, the configurations may be set in a more accurate and convenient manner.

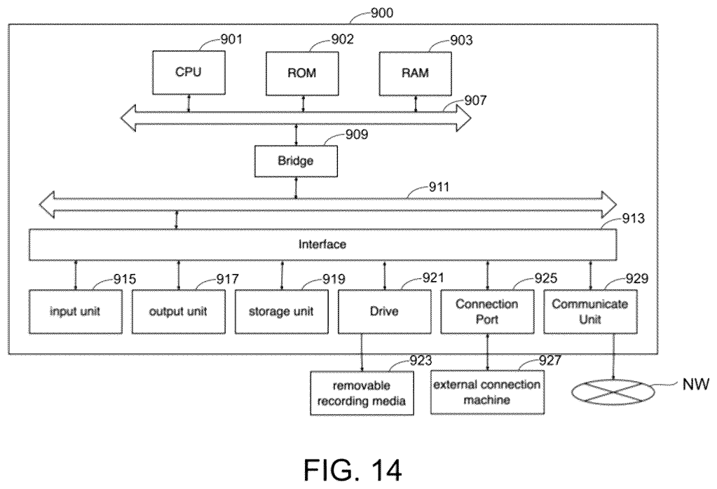

FIG. 14 is a schematic block diagram of computer hardware for carrying out a system configuration and processing according to some embodiments of subject application. The information processing device 900 in FIG. 14 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 and configuration setting system 2 have been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

### LIST OF REFERENCE NUMBERS

1 Live streaming system 10 Server
20 User terminal 100 Streaming unit
102 Video control unit 104 Audio control unit
106 Distribution unit 108 UI control unit
200 Viewing unit 202 UI control unit
204 Rendering unit 206 Input unit
30, 30a, 30b User terminal 302 Providing unit
304 Relay unit 306 Configuration unit
308 Converting unit 310 Visualization unit
320 Configuration storage 322 Definition storage
600 visual editor 602 UI object
604 title 606 Input field
608 Object 610 Preview
612 code info 614 switch
900 Information processing device 901 CPU
903 ROM 905 RAM
907 Host bus 909 Bridge
911 External bus 913 Interface
915 Input unit 917 Output unit
919 Storage unit 921 Drive
923 Removable recording medium 925 Connection port
927 External connection device 929 Communication unit
LS Live streaming LV Streamer
NW Network SP Specific portion
AU1, AU2 Viewer
S520-S580 Step
VD, VD1, VD2 Video

What is claimed is:

1. A server for setting configurations in live streaming platform, comprising one or a plurality of processors, wherein the one or plurality of processors execute a machine-readable instruction to perform:
obtaining configuration setting data from a database; wherein the configuration setting data includes configuration file and definition file;
generating an UI object according to the configuration setting data;
receiving an operation from an user via the UI object; and
updating the configuration setting data in the database.

2. The server according to claim 1, wherein:
the configuration file includes parameters for setting configuration; and
the definition file includes definitions of the parameters.

3. The server according to claim 1, further comprising:
verifying the operation according to the definition file; and
displaying guidance in response to an error on the operation.

4. The server according to claim 1, wherein
the configuration file and definition file have the same filename with different file extensions; and
existence of the definition file is checked according to the filename.

5. The server according to claim 1, further comprising:
transforming the configuration file into Document Nodes; and
converting the Document Nodes into JSON objects.

6. The server according to claim 1, further comprising:
transforming parameters in the configuration file into corresponding components according to format of the parameters; wherein
the parameters with the same format are transformed into the same component.

7. The server according to claim 1, further comprising:
updating the operation on the UI object dynamically in response to the operation from the user; wherein
the UI object includes a visual editor and/or a code editor.

8. The server according to claim 1, wherein
the configuration setting data includes parameters related to interactions among streamers and viewers in the live streaming platform.

9. A method for setting configurations in live streaming platform, comprising:
obtaining configuration setting data from a database; wherein the configuration setting data includes configuration file and definition file;
generating an UI object according to the configuration setting data;
receiving an operation from an user via the UI object; and
updating the configuration setting data in the database.

10. A non-transitory computer-readable medium including program instructions, that when executed by one or more processors, cause the one or more processors to execute:
obtaining configuration setting data from a database; wherein the configuration setting data includes configuration file and definition file;
generating an UI object according to the configuration setting data;
receiving an operation from an user via the UI object; and
updating the configuration setting data in the databa
